(19) United States
(12) Patent Application Publication
(10) Pub. No.: US 2008/0105498 A1
(43) Pub. Date: May 8, 2008

(54) JOINT ASSEMBLY AND RELATED METHODS

(75) Inventor: Gerard T. Perkins, Ashland, OH (US)

Correspondence Address: PERKINS COIE LLP;PATENT-SEA, P.O. BOX 1247, SEATTLE, WA, 98111-1247, US

(73) Assignee: Genie Industries, Inc., Redmond, WA (US)

(21) Appl. No.: 11/762,026

(22) Filed: Jun. 12, 2007

Related U.S. Application Data
(60) Provisional application No. 60/813,300, filed on Jun. 12, 2006.

(51) Int. Cl. B66B 9/16

(52) U.S. Cl. 187/269

(57) ABSTRACT

A structural member is provided in an embodiment for a lift assembly. The structural member comprises an elongated member having a pair of spaced apart sidewalls with a pair of aligned apertures therein. A joint assembly comprises a support member is positioned between the sidewalls and aligned with the apertures. The support member has an outer dimension greater than the diameter of the apertures so the support member will not pass through the apertures. An interior sleeve is disposed adjacent to the support member and extends through the apertures. The interior sleeve has end portions projecting beyond the sidewalls. The end portions are cold worked, radially flared portions adjacent to the sidewalls. The radially flared portions have an outer diameter greater than the diameter of the apertures. A portion of the sidewalls around the apertures are fixedly captured between the radially flared portion of the interior sleeve and the support member.

### CROSS REFERENCE TO RELATED APPLICATION

The present patent application is a non-provisional patent application that claims priority to U.S. provisional Patent Application No. 60/813,300, filed Jun. 12, 2006, which is incorporated herein in its entirety by reference thereto.

### TECHNICAL FIELD

The present invention is directed to joint assemblies for pivoting and non-pivoting assemblies, and more particularly to structural members and joint arrangements for pivoting and non-pivoting assemblies.

### BACKGROUND

Aspects of the prior art are described below and shown in FIGS. 1-3 for purposes of background. FIG. 1 is a partially exploded isometric view of a conventional scissor lift assembly 10 having a chassis 12 coupled to a platform 14 by a plurality of scissoring link sets 16. Each link set 16 includes a pair of outer link arms 18 pivotably attached to a pair of inner link arms 20. The link arms are very strong steel, welded members having a box-shaped cross-sectional shape, but the are heavy and expensive. The outer link arms in a link set are pivotably attached to the inner link arms of that link set at a midpoint that allows for the scissoring action between the inner and outer link arms. The ends of the inner link arms of a link set are pivotably connected to the ends of outer link arms of the next higher or lower link set, or to the platform or the chassis, depending upon the position of the link set in the scissor lift assembly. The inner link arms are connected to the outer link arms by a pivot pin 23 that extends through welded, sometimes reinforced, joint portions 22 of the respective link arms. The inner and outer link arms and the pivot pins can be subjected to significant loads (e.g., axial and torsional loads) and stresses during operation of the scissor lift assembly.

FIG. 2 is an enlarged isometric view of an outer link arm 18 shown removed from a link set 16 of FIG. 1. FIG. 3 is an enlarged cross-sectional view taken substantially along line 3-3 of FIG. 2, with the joint portion 22 and link arm shown in solid lines and a pivot pin 23 shown in phantom lines. The joint portions on the link arm include a steel sleeve 24 that extends through a pair of holes 26 found in opposing sidewalls of the link arm. The steel sleeve is welded to the link arm around one of the holes. The steel sleeve also extends through the hole in the opposite sidewall and through a steel reinforcement plate 28 welded to the sidewall generally adjacent to the hole. The welded steel reinforcement plate provides additional structure around the holes to help strengthen the link arm at the joint portions and to help avoid stress cracks in the welds through the operational life of the link arm and the joint portion. The steel sleeve pivotally receives the pivot pin 23 (shown in phantom lines) so the link arm can pivot about the pivot pin. Several link arms in a link set also often include welded support plates or reinforced structures to which other assemblies are securely connected. These plates and structures add to the weight, cost and manufacturing process for each link set.

As shown in FIG. 3, the conventional steel sleeve 24 in the reinforced joint portion 22 typically also includes bushings 30 mounted in counter bores 32 formed in the ends of the sleeve. The bushings are positioned to engage the pivot pin 23 to provide for a low friction interface with the pivot pin. Accordingly, the steel sleeve must be machined and assembled with the bushings, thereby adding to the overall cost of the assembled link arm, and thus, the scissor lift assembly.

The welded construction of the steel link arm subjects the link sets 16 of the scissor lift assembly 10 (FIG. 1) to internal stresses that distort the shape and fit of the component parts, which can damage the assembled bushings and create misalignment of mated joint assemblies. This distortion and misalignment prevents the scissors lift from raising and lowering smoothly, creating stiff joints and jerky motion. Since the joints are not free moving, greater force is required to effect movement, higher hydraulic operating pressure is required, and components are subjected to higher operating stress that manifests itself in reduced working life and excessive energy consumption. The resulting misalignment requires the use of highly resilient and expensive bushings to attempt to compensate the welding and fabrication processes. Additionally, the welded construction is time consuming and labor intensive, while requiring high energy input. The welded, steel, box-beam link arms result in a very heavy link set that requires heavy duty motors, actuators, hydraulics, and other components to reliably and smoothly operate the link set over the life of the scissor-lift assembly, all of which increase the cost and weight of the assembly. In addition, the heavy link arms can be difficult or cumbersome to handle by personnel and machines during the manufacturing process. The inventor has recognized the need for improved joint assemblies that can easily, quickly and securely interconnect members, such as structural members, beams, or link arms used in lift assemblies to provide a lighter weight, less expensive assemblies.

### SUMMARY

The present invention provides a pivot joint assembly for a pivoting structure that overcomes drawbacks of the prior art and provides other benefits. One embodiment provides a link arm assembly for use in a link set of a scissor lift assembly. The link arm assembly comprises a link arm having a pair of sidewalls spaced apart from each other. Each of the sidewalls has a plurality of apertures with a first diameter. Each apertures in one sidewall is axially aligned with another one of the apertures in the other sidewall. A joint assembly comprises a support sleeve positioned between the sidewalls and aligned with a pair of the apertures in the sidewalls. The support sleeve has an outer diameter greater than the first diameter of the apertures. An interior sleeve is concentrically disposed within the support sleeve. The interior sleeve has end portions extending through the pair of apertures and projecting beyond the sidewalls. The end portions have cold worked, radially flared portions adjacent to the sidewalls. The radially flared portions have a diameter greater than the first diameter of the apertures. A portion of the sidewalls around the aperture is fixedly captured between the radially flared portion of the interior sleeve and the support sleeve.

In another embodiment, a scissor lift assembly comprises a plurality of link arms pivotally coupled together to form an scissoring link set. Each link arm has a pair of sidewalls spaced apart from each other. Each of the sidewalls has a plurality of apertures. Each of the apertures in one sidewall of a link arm is axially aligned with another one of the apertures in the other sidewall. A plurality of joint assemblies is attached to the link arms. Each joint assembly has an interior sleeve extending through the pair of apertures and end portions projecting beyond the sidewalls. The end portions have cold worked, radially flared portions adjacent to the sidewalls. The end portions are in fixed engagement with portions of the sidewalls around the apertures. The radially flared portions have a diameter greater than the diameter of the apertures. A pivot member is connected to adjacent joint assemblies of two adjacent link arms and configured allow the two adjacent link arms to pivot relative to each other at the joint assemblies and about the pivot member.

In another embodiment, a structural member for a lift assembly comprises an elongated member having a pair of spaced apart sidewalls with a pair of aligned apertures therein. A joint assembly comprises a support member is positioned between the sidewalls and aligned with the apertures. The support member has an outer dimension greater than the diameter of the apertures so the support member will not pass through the apertures. An interior sleeve is disposed adjacent to the support member and extends through the apertures. The interior sleeve has end portions projecting beyond the sidewalls. The end portions are cold worked, radially flared portions adjacent to the sidewalls. The radially flared portions have an outer diameter greater than the diameter of the apertures. A portion of the sidewalls around the apertures are fixedly captured between the radially flared portion of the interior sleeve and the support member.

In another embodiment a joint assembly comprises a first member having a first aperture, and a second member spaced apart from the first member and having a second aperture axially aligned with the first aperture. A support member is positionable between the first and second members to support at least a portion of the first and second members. The support member is in alignment with the apertures. The support member is sized so the support member will not pass through the apertures. An interior sleeve is disposed adjacent to the support member and extends between the first and second members and through the first and second apertures. The interior sleeve has end portions projecting beyond the first and second members. The end portions are cold worked, radially flared portions adjacent to the first and second members about the first and second apertures. The radially flared portions have an outer diameter greater than the diameter of the first and second apertures, and wherein portions of the first and second member around the first and second apertures are fixedly captured between the radially flared portions of the interior sleeve and the support member.

In yet another embodiment, a method of joining first and second member having apertures therein is provided. The method comprises securing the first and second members in a spaced apart relationship with the apertures axially aligned with each other. A support member is placed adjacent to the apertures and between the first and second members and to block the first and second members from moving toward each other past a selected distance. An interior sleeve is inserted through the aligned apertures in the first and second members, wherein unflared end portions project away from the first and second members in opposite directions. The end portions of the interior sleeve are radially flared by cold working the end portions. The first and second members around the apertures are fixedly captured between the radially flared portions of the interior sleeve and the support member to lock the joint assembly in place.

### BRIEF DESCRIPTION OF THE DRAWINGS

FIG. 1 is a partially exploded isometric view of a prior art scissor lift assembly with a plurality of link sets.

FIG. 2 is an enlarged isometric view of a prior art external link member shown removed from one of the link sets of FIG. 1.

FIG. 3 is an enlarged cross-sectional view taken substantially along line 3-3 of FIG. 2 showing the prior art link arm and pivot joint portion.

FIG. 4 is an isometric view of a scissor lift assembly with link sets having link arms and joint assemblies in accordance with an embodiment of the present invention.

FIG. 5 is a bottom isometric view of a link arm shown removed from the link sets of the scissor lift assembly of FIG. 4; the link arm has three joint assemblies in accordance with an embodiment of the present invention.

FIG. 6 is a partially exploded isometric view of the link arm and joint assemblies of FIG. 5.

FIG. 7 is an enlarged cross-sectional view taken substantially along line 7-7 of FIG. 5 showing one of the joint assemblies.

FIG. 8 is an isometric view of a link arm and three joint assemblies in accordance with another embodiment, wherein the link arm has an access hole adjacent to at lease one of the joint assemblies.

FIG. 9 is an isometric view of a link arm in accordance with another embodiment, wherein the link arm has joint apertures that receive joint members and access apertures adjacent to the joint apertures.

FIG. 10 is a bottom isometric view of a link arm with joint assemblies in accordance with another embodiment of the invention.

FIG. 11 is an enlarged cross-sectional view taken substantially along line 11-11 of FIG. 10 showing one of the joint assemblies.

FIG. 12 is a bottom isometric view of a link arm with three joint assemblies in accordance with another embodiment of the invention.

FIG. 13 is an enlarged cross-sectional view taken substantially along line 13-13 of FIG. 12 showing one of the joint assemblies.

FIG. 14 is an enlarged cross-sectional view of a link arm and a joint assembly in accordance with another embodiment of the present invention.

FIG. 15 is an isometric view of a link arm with three joint assemblies in accordance with another embodiment of the invention.

FIG. 16 is an enlarged isometric view of an interior sleeve of a joint assembly shown with flared ends and removed from the link arm of FIG. 15.

FIG. 17 is an enlarged isometric view of a spacer shown removed from the link arm of FIG. 15.

FIG. 18 is an isometric view of the link arm and the joint assemblies with the interior sleeve shown in position relative to the link arm and the spacer, with the ends of the interior sleeve in a straight configuration before being flared radially outwardly into engagement with the spacer.

FIG. 19 is an isometric view of a link arm and joint assemblies in accordance with another embodiment, wherein the link arm include a pair of spaced apart flanged plates rigidly connected together by the joint assemblies.

FIG. 20 is an enlarged cross-sectional view taken substantially along line 20-20 of FIG. 19.

FIGS. 21A-21C are schematic cross-sectional views illustrating a joint forming method in accordance with an embodiment of the present invention.

FIG. 22 is a schematic cross-sectional view of a first flaring die positioned in a joint assembly during the formation of the joint assembly in accordance with another embodiment of the present invention.

FIG. 23 is a schematic cross-sectional view of a second flaring die positioned in the joint assembly of FIG. 22 during the formation of the joint assembly in accordance with an embodiment of the present invention.

### DETAILED DESCRIPTION

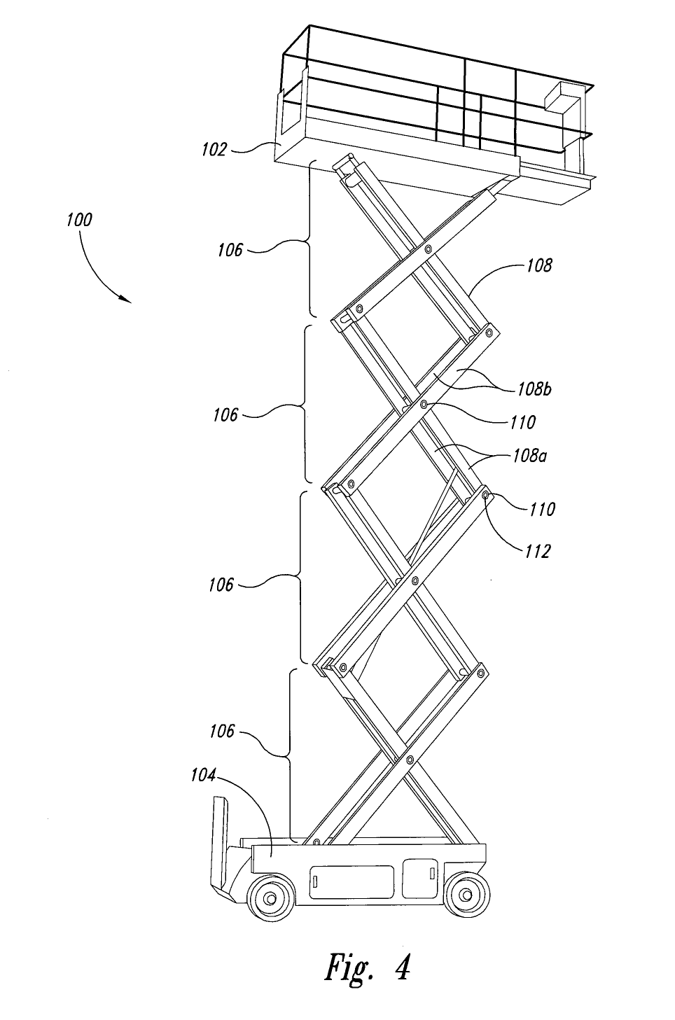

Embodiments of the present invention include structures with improved joint assemblies, along with methods for making the joint assemblies. Several specific details of the invention are set forth in the following detailed description and in FIGS. 4-23 to provide a thorough understanding of embodiments of the invention. The embodiments are illustrated in the Figures and described below in connection with a scissor lift assembly with link arms pivotably coupled together by pivot joint assemblies One skilled in the art, however, will understand that the present invention is applicable to joining or forming other structural or non-structural members with one or more joint assemblies for a fixed or movable interconnections therebetween. Further, the present invention may have additional embodiments, and that other embodiments of the invention may be practiced without one or more of the specific features described below. In other instances, well-known structures, materials, or operations are not shown or described in order to avoid obscuring aspects of the invention.

FIG. 4 is an isometric view of a scissor lift assembly 100 having link arms with joint assemblies pivotably coupled together in accordance with an embodiment of the present invention. The scissor lift assembly 100 includes a platform 102 coupled to a chassis 104 by a plurality of link sets 106. The link sets are formed by a plurality of link arms 108, including a pair of interior link arms 108a and a pair of exterior link arms 108b coupled together by joint assemblies 110 in the link arms and a pivot pin 112 extending through adjacent joint assemblies. In the illustrated embodiment, the interior and exterior link arms have substantially the same construction.

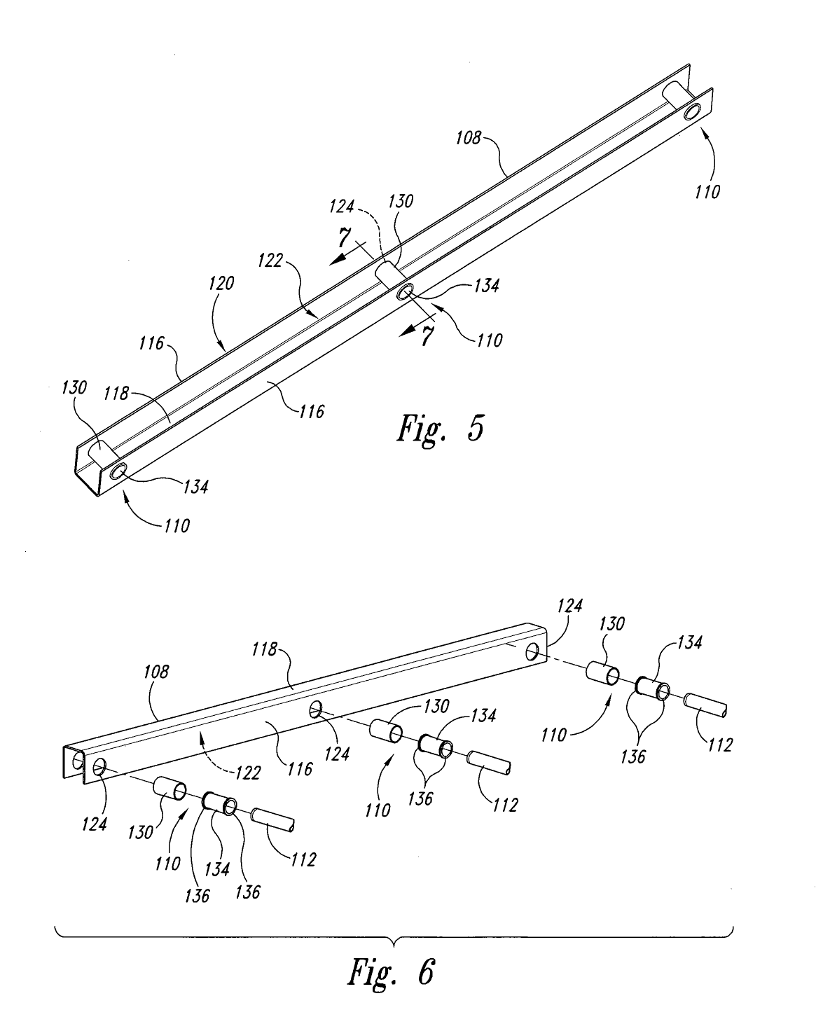

FIG. 5 is a bottom isometric view of a link arm 108 shown removed from the scissor lift assembly 100 of FIG. 4. The illustrated link arm 108 has three joint assemblies 110 in accordance with an embodiment of the present invention. FIG. 6 is a partially exploded isometric view of the link arm 108 and joint assemblies 110 of FIG. 5.

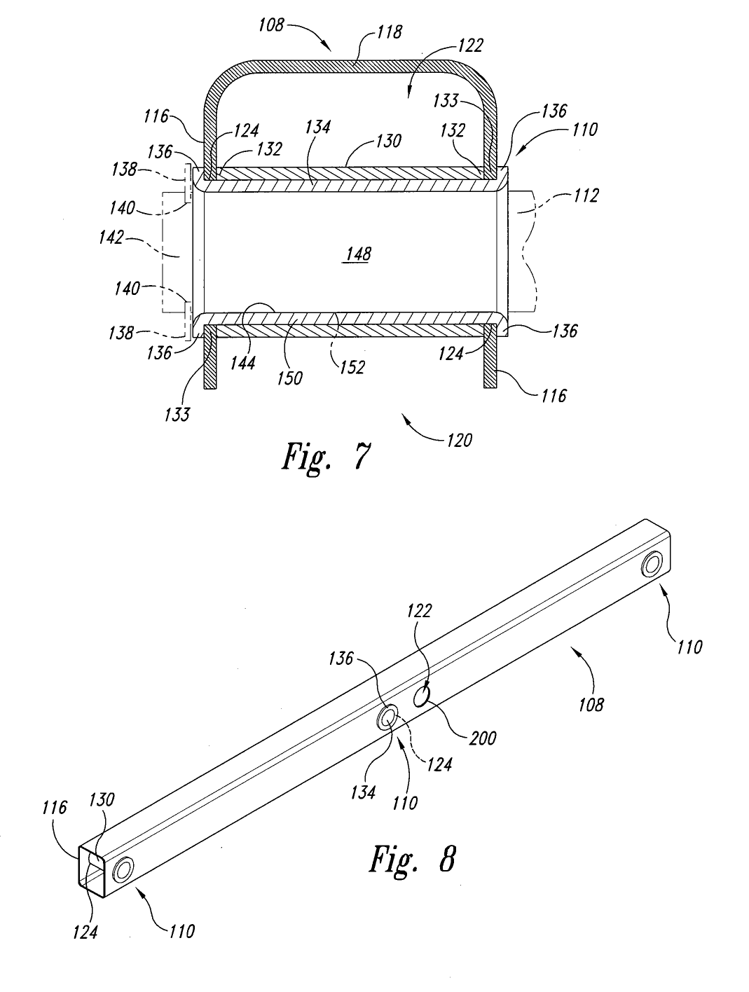

FIG. 7 is an enlarged cross-sectional view of the link arm and joint assembly taken substantially along line 7-7 of FIG. 5. It is to be understood that while the arm and joint assemblies are described and shown herein in connection with link sets in a scissor lift assembly, the arm structure and one or more joint assemblies of the present invention can be used for other assemblies.

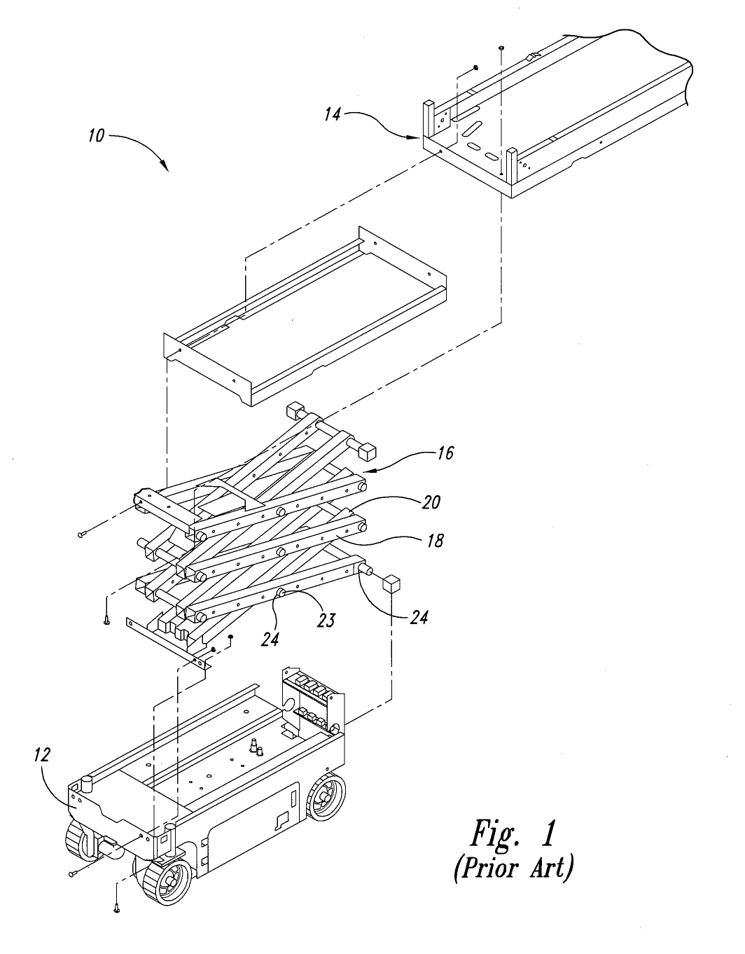

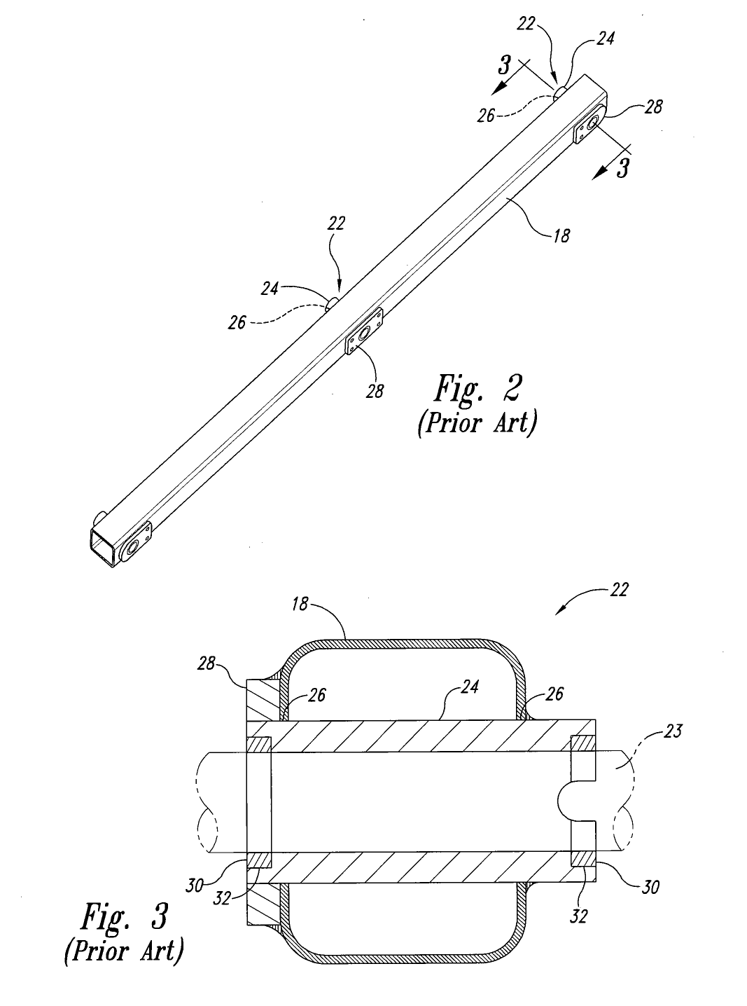

As best seen in FIGS. 5 and 7, the illustrated link arm 108 is a U-shaped channel member having a pair of sidewalls 116 interconnected by an end wall 118. The channel has an open end 120 opposite the end wall so as to provide access into the interior area 122 of the channel. In other embodiments, link arms 108 can have other channel configurations, such as a C-channel or other suitable open configuration. In yet other embodiments, the link arm can be formed of a tubular member having a box construction or other suitable closed configuration. The channel configuration of the link arm provides a durable, open structure. The open end of the channel also allows access into the interior area for ease of manufacturing the link arm and pivot joint assembly (discussed in greater detail below). The open end also allows for easy access to the interior area for applying coatings, such as paint, a corrosion-resistant coating, or other materials, within the link arm. The interior area of the link arm could also be used as storage space for components of the scissor lift assembly (FIG. 1) or other assembly in which the link arm and joint assembly are used.

As best seen in FIGS. 6 and 7, the sidewalls 116 of the link arm 108 include a pair of axially aligned apertures 124 formed therein. In the illustrated embodiment, the link arm includes three sets of apertures 124 (see FIG. 6), including a set at each end of the link arm and a set at the center portion of the link arm. Each set of the apertures 124 receives a joint assembly 110.

The joint assembly 110 of the illustrated embodiment includes an outer support sleeve 130 positioned in the interior area 122 of the link arm 108 and coaxially aligned with a set of the apertures 124 in the sidewalls 116. The support sleeve has a length that approximates the distance between the sidewalls. Accordingly, the support sleeve can be easily and quickly positioned in the interior area through the link arm's open end 120 during assembly of the link arm and joint assembly. The support sleeve has an outer diameter greater than the diameter of the apertures in the sidewalls. In the illustrated embodiment, the support sleeve has an inner diameter substantially equal to or slightly larger than the diameter of the aperture. Accordingly, the ends 132 of the support sleeve are immediately adjacent to the portions of the sidewalls around the apertures.

The support sleeve 130 of the illustrated embodiment is made from stock steel tube easily cut to size to fit snuggly between and abut the sidewalls 116. Accordingly, the support sleeve acts as a structural element that provides lateral support to the link arm 108. The support sleeve also blocks the sidewalls 116 of the channel from deflecting toward each other. The support sleeve 130 also acts as a cross brace when the joint is assembled to help maintain torsional rigidity to the link arm.

In other embodiments, a closed channel could be used for the link arm 108. The support sleeves 130, if used, could be positioned within the closed channel through an open end or other portion that allows access into the interior area 122. As an example, FIG. 8 is an isometric view of a link arm 108 and three joint assemblies 110 in accordance with another embodiment, wherein the link arm 108 has an access hole 200 adjacent to at least one of the joint assemblies. The access hole 200 provides access to the interior area 122 of the link arm, so a person or machine can engage and hold the support sleeve 130 in axial alignment with the apertures 124 during installation of the joint assembly 110.

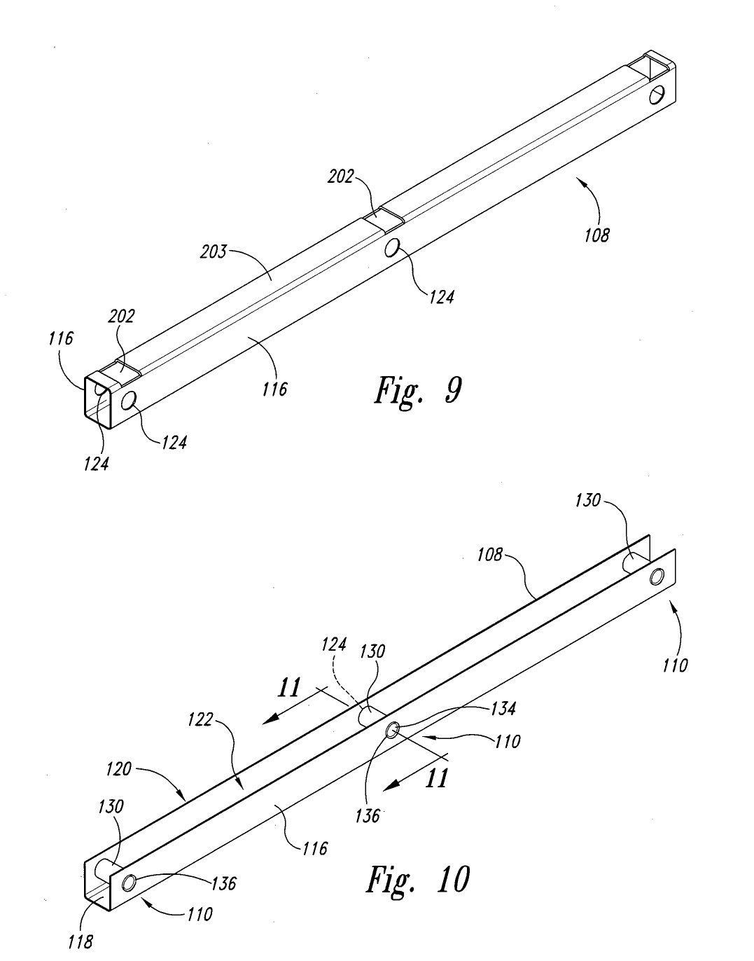

FIG. 9 is an isometric view of a link arm 108 in accordance with another embodiment, wherein the link arm has the apertures 124 that receive the joint assemblies 110 (FIG. 8). The link arm also has access apertures 202 adjacent to the joint apertures. The link arm 108 of the illustrated embodiment has a steel box-beam construction with the axially aligned apertures 124 formed in the sidewalls 116. In this embodiment, the access apertures 202 are provided in the end wall 203, which extends between the sidewalls 116 above each of the joint apertures 124. The access aperture 202 provides access to the interior area 122 of the link arm 108, for example, to allow a person or machine to temporarily hold the support sleeve 130 (FIG. 8) in axial alignment with the joint apertures 124. In other embodiments, the access holes 202 is shaped and sized to allow a temporary support member to be placed in the interior area 122 so as to span between and support the sidewalls 116 during assembly of the joint assembly (as discussed in greater detail below). The temporary support can then be removed after the joint assembly is installed.

As best seen in FIG. 7, the joint assembly 110 of the illustrated embodiment also includes an interior sleeve 134 that extends through the apertures 124 in the sidewalls 116 and through the support sleeve 130. Accordingly, the support sleeve 130 and the interior sleeve 134 are axially aligned and concentrically oriented, although the interior sleeve is longer than the support sleeve. The interior sleeve 134 of the illustrated embodiment has an outer diameter that approximates the diameter of the apertures 124, so the interior sleeve can be easily yet snuggly inserted through the aperture during the manufacturing process. The ends 136 of the interior sleeve 134 that extend beyond the sidewalls 116 are flared radially outwardly and are positioned immediately adjacent to the portions 133 of the sidewalls 116 around the aperture 124.

In the illustrated embodiment, each of the flared ends 136 is positioned such that the portion 133 of the sidewall 116 around each aperture 124 is tightly held between the flared end of the interior sleeve and the end 132 of the support sleeve 130. This tight joint formed by the sidewall 116, the support sleeve 130, and the interior sleeve 134 rigidly retains the components of the joint assembly in a fixed position relative to the link arm 108 without using any welds. The rigid connection of the support sleeve and the interior sleeve with the sidewalls of the channel-shaped link arm also adds axial and torsional stiffness of the link arm. In other embodiments where additional torsional or axial stiffness may be desired, additional stiffeners may be connected to the sidewalls and/or provided within the interior area 122 of the link arm and secured in place easily through access to the interior area through the link arm's open end 120.

During a manufacturing process to assemble the link arm 108 and the joint assemblies 110, the interior sleeve 134 is a length of straight tubing (prior to having the ends flared or otherwise radially expanded), and the interior sleeve is positioned through a set of the apertures 124 in the sidewalls 116 and through the support sleeve 130. In the illustrated embodiment, the interior sleeve 134 is a section of stock hydraulic tube cut to length, although other suitable material can be used for the interior sleeve in other embodiments. The ends 136 of the interior sleeve are then flared, as discussed in greater detail below. Accordingly, the ends 136 of the interior sleeve 134 in the illustrated embodiment are cold-worked and radially expanded into rigid engagement with the sidewall 116 of the link arm 108, thereby providing the rigid interconnection between the link arm and the joint assembly. It is noted that, while the manufacturing process is discussed in connection with a joint assembly 110 for pivotal interconnection of link arms, the joint assembly can be used for joining two or more members in a fixed, non-moveable orientation.

In the illustrated embodiment, the ends 136 of the interior sleeve 134 are flared into approximately a 90° angle. A flared portion of the sleeve's end 136 abuts against the portion 133 of the sidewall 116 around the aperture 124, and that portion of the sleeve's end is in direct alignment with the support sleeve. Accordingly, when the interior sleeve 134 is cold worked, both ends 136 are flared simultaneously, and the support sleeve 130 reacts to forces exerted against the sidewalls 116, thereby blocking the sidewalls from flexing inwardly. While the illustrated embodiment is discussed in connection with flaring the ends of the interior sleeve, other cold-working techniques, such as cold heading, staking, or other techniques, could be used for upsetting the ends of the interior sleeve to provide a radially expanded portion with a diameter greater than the diameter of the apertures 124 in the sidewalls 116. Accordingly, the link arm 108 and the joint assembly 110 are assembled without welding any of the components. This “weldless” construction is more efficient, less labor intensive, and less expensive than the conventional welded construction of a reinforced scissor link arm.

Referring again to FIG. 7, the interior sleeve 134 is shaped and sized to pivotably receive the pivot pin 112 (shown in phantom lines) therethrough. In the illustrated embodiment, the pivot pin is retained in place and blocked from pulling back through the interior sleeve by a snap ring 138 or other retention device positioned within a groove 140 formed in the end portion 142 of the pivot pin. The pivot pin has an outer diameter that approximates the inner diameter of the interior sleeve 134 such that the joint assembly and link arm can pivot about the pivot pin.

In one embodiment, the interior surface of the interior sleeve 134 is formed by a layer of lubricious material adhered to the body 150 of the interior sleeve to form a bearing surface 148. The bearing surface 148 is configured to engage and slide against an outer surface 152 of the pivot pin 112 without substantial frictional losses. In the illustrated embodiment, the bearing surface 148 is provided by coating the inside of the interior sleeve with a lubricious material, such as an electroless nickel, bronze, or non-metallic coating. The electroless nickel plating can also be impregnated with a lubricious material. In one embodiment, the electroless nickel plating is impregnated with Teflon® (i.e., PTFE). In another embodiment, the pivot pin is provided with a bearing surface coating that slideably engages the inside of the interior sleeve. In yet another embodiment, both the pivot pin and the interior sleeve can be provided with bearing surface coatings that slideably engage each other.

The lubricious bearing surface coating is configured such that additional bearings and/or bushings are unnecessary within the interior sleeve 134 for engagement with the pivot pin 112. The bearing surface coating can also provide corrosion protection in the interior sleeve and/or on the pivot pin. Accordingly, the joint assembly 110 of the illustrated embodiment is a bearingless assembly, because additional bearing components or bushings are not used between the interior sleeve and the pivot pin, while still allowing for smooth, efficient, and effective rotational movement of the link arm under working loads. However, discrete bearings or bushings may be employed as well in other embodiments.

While the above embodiment uses a coating that is impregnated or otherwise applied to the inside of the interior sleeve 134 or to the outside of the pivot pin 112 or both, other coating materials, impregnation processes, or other materials of the joint assembly can be used to achieve the lubricious engagement between the pivot pin and the interior sleeve. This configuration can also allow for a reduced exterior size of the joint assembly 110, which may affect the size and/or amount of material needed in the link arm 108 to operatively support the pivot joint assembly and to withstand the operational loads on the link arm. In addition, the joint assembly utilizes fewer parts, and the parts can be made from stock components. The resulting weldless manufacturing process is easier, faster, non-distorting, and less expensive link arm and joint assembly that can be used in a scissor lift assembly or other pivoting structure. The link arm and joint assembly of the illustrated embodiment are also easier to maintain, repair, or replace in the field, thereby decreasing the amount of time the scissor lift assembly or other pivoting structure is out of service.

The arrangement of the link arm 108 and joint assembly 110 can be used for both the interior link arm 108a and the exterior link arm 108b of a link set 106 for a scissor lift assembly (FIG. 4). Washers, such as non-metallic low friction washers, and/or other spacers can be provided between connected link arms (e.g., on the pivot pins) as needed during assembly based upon the size and overall configuration of the scissor lift assembly. In one embodiment, the link arm and joint assemblies are provided for a scissor lift assembly, and interior link arms 108a are spaced apart from each other within a link set. The pivot pin 112 can be an elongated pivot pin and a spacer (not shown) can be provided over the pivot pin between the interior link arms to help maintain the spacing of the interior link arms relative to each other during assembly and operation of the link sets. Other spacing configurations can be used for the interior and/or exterior link arms in other embodiments.

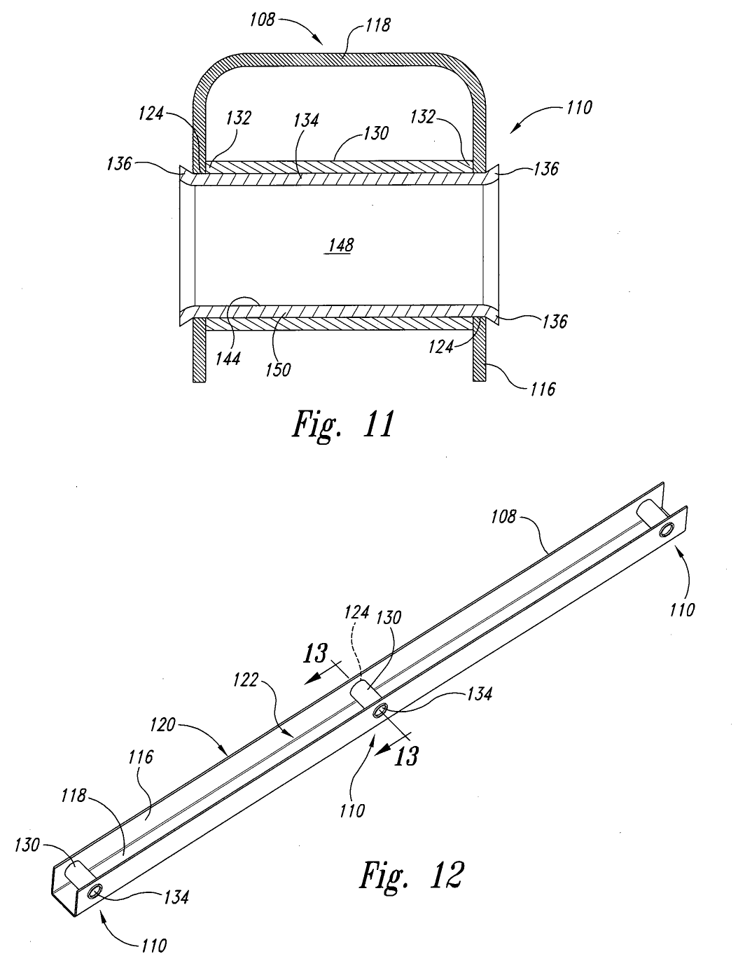

FIG. 10 is a bottom isometric view of a link arm 108 and joint assemblies 110 in accordance with another embodiment of the invention. FIG. 11 is a cross-sectional view taken substantially along line 11-11 of FIG. 10. In this embodiment, the link arm 108 is a U-channel, substantially as discussed above. The joint assembly has the support sleeve 130 positioned within the interior area 122 of the link arm substantially coaxially aligned with the apertures 124 in the sidewalls 116, also as discussed above. In this illustrated embodiment, the interior sleeve 134 extends through the support sleeve 130 and the apertures 124 in the link arm. The interior sleeve is radially expanded at its ends 136 to a diameter greater than the diameter of the apertures. In the illustrated embodiment, the ends 136 are radially expanded to provide an angle relative to the adjacent sidewall 116 of less than 90°. In the illustrated embodiment, the ends of the interior sleeve are radially expanded to form an angle of approximately 45° relative to the adjacent sidewall. The approximately 45° angle provides a tight joint between the interior sleeve, the support sleeve, and the sidewall around the apertures. While the illustrated embodiment utilizes a 45° angle, other embodiments can be radially expanded to other angles relative to the adjacent sidewall to provide the tight joint of the joint assembly.

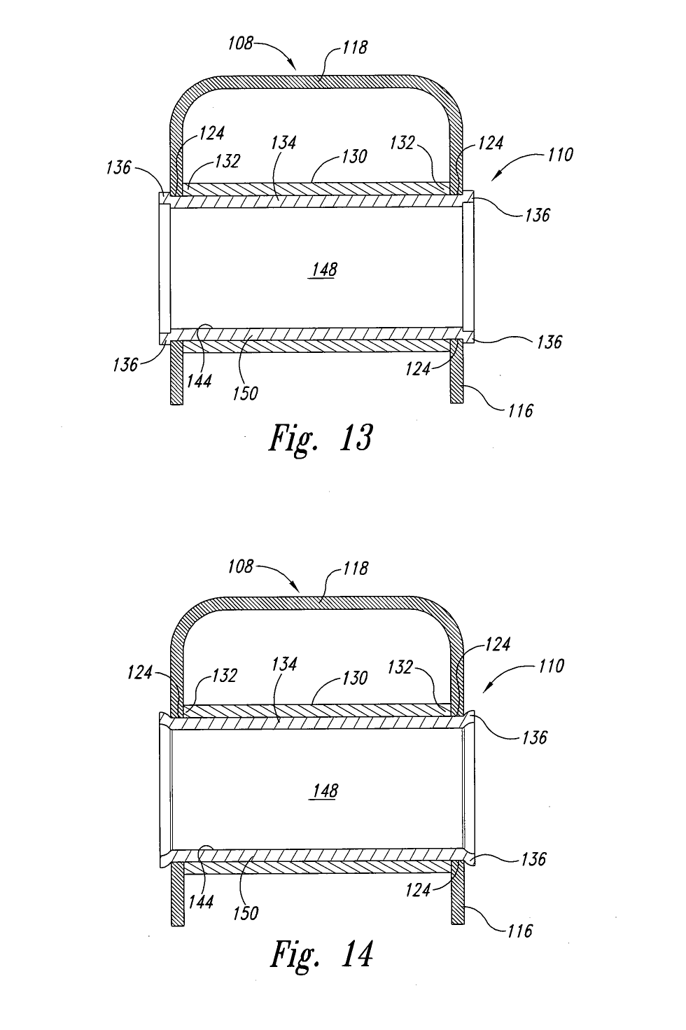

FIG. 12 is a bottom isometric view of a link arm 108 with joint assemblies 110 in accordance with yet another embodiment. FIG. 13 is an enlarged cross-sectional view taken substantially along line 13-13 of FIG. 12, showing the joint assembly 110 in the link arm. In the illustrated embodiment, the link arm is a U-shaped channel substantially as discussed above. The support sleeve 130 is axially aligned with the apertures in the sidewalls 116 and extends between sidewalls as discussed above. The interior sleeve 134 is positioned within the apertures 124 and extends through the support sleeve, also as discussed above. In the illustrated embodiment, the ends 136 of the interior sleeve are mechanically upset by staking the ends to create a stepped arrangement at the ends. The stepped structure at the end of the interior sleeve securely retains the portion of the sidewall around the aperture against the end of the support sleeve. Accordingly, the joint assembly is rigidly fixed to the link arm without having to weld the components together.

FIG. 14 is a cross-sectional view of another embodiment having the link arm 108, the support sleeve 130, and the interior sleeve 134 substantially as discussed above. The ends 136 of the support sleeve, however, have been cold-worked to radially expand the ends to a diameter larger than the diameter of the apertures 124 to securely lock the support sleeve 130, the interior sleeve 134, and the portion of the sidewalls around the apertures in place. In other embodiments, the ends of the interior sleeve can be mechanically upset by other cold-working techniques or other techniques to provide the radially enlarged end portions, thereby providing the non-welded mechanical joint between the link arm, the support sleeve, and the interior sleeve.

In yet other embodiments, the internal sleeve 134 can be securely and rigidly retained in place in the link arm 108 by other non-welded, mechanical locking mechanisms without having to physically expand the ends 136 of the interior sleeve. For example, the pivot pin can be provided with two annular grooves positioned to be adjacent to each end of the internal sleeve and/or adjacent to the sidewalls of the link arm. Snap rings can be releasably locked to the pivot pin in the annular grooves so as to abut the internal sleeve. If the internal sleeve's length is equal to or less than the width of the link arm, then the snap rings will abut the sidewalls of the link arm. Other non-welded, mechanical locking means can be used in other embodiments. For example, the ends of the interior sleeve can be provided with grooves positioned to be adjacent to the sidewalls. Snap rings or other mechanical locking mechanisms can be attached to the interior sleeve to lock the sleeve in position to create a substantially rigid joint relative to the sidewalls. In these alternate embodiments that do not flare the ends of the interior sleeve, tolerances of the interior sleeve, the width of the link arm, the distance between the sidewalls, and the mechanical connectors are selected to achieve the tight joint between the components.

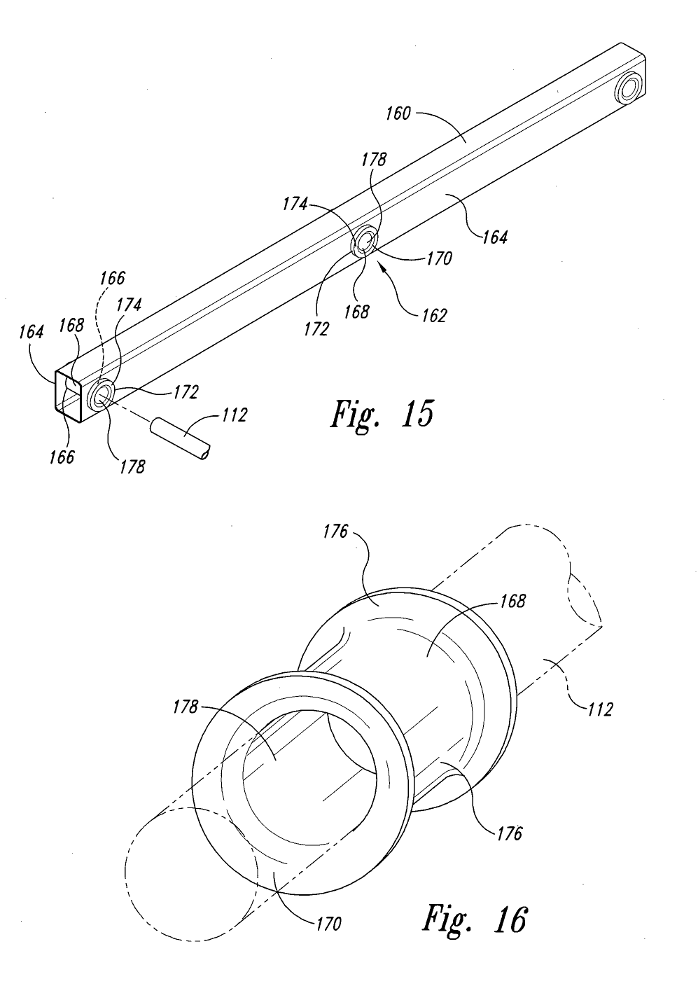

FIG. 15 is an isometric view of a link arm 160 with three joint assemblies 162 in accordance with another embodiment of the invention. The illustrated link arm is a tubular member having a rectangular or square cross-sectional shape, although other embodiments can use a link arm having a channel configuration as discussed above or other tubular shapes. The link arm has opposing sidewalls 164 with an opposing set of apertures 166 in the sidewalls for each joint assembly. The joint assembly includes a sleeve 168 that extends through a set of the opposing apertures. As best seen in FIG. 16, the ends 170 of the sleeve 168 (which are shown removed from the joint assembly) are flared radially outwardly and have a diameter greater than the diameter of the apertures (FIG. 13). Referring again to FIG. 15, the joint assembly also includes at least one spacer 172 securely sandwiched between the flared end 170 of the sleeve and the sidewall of the link arm. In the illustrated embodiment, each joint assembly includes two spacers positioned on opposite sides of the link arm. The sleeve extends through holes 174 in the spacers, and each flared end of the sleeve securely holds a spacer against the adjacent sidewall of the link arm. This spacer also serves to add rigidity to the section.

As best seen in FIG. 16, the sleeve 168 is configured to receive a pivot pin 112 (shown in phantom lines) therethrough such that the link arm can pivot about the pivot pin. The sleeve 168 can have an interior surface defined by a lubricious material adhered to the body 176 of the sleeve to form a bearing surface 178, discussed above. In another embodiment, the pivot pin has the lubricious bearing surface as discussed above that engages the interior of the sleeve. In another embodiment, both the sleeve and the pivot pin have lubricious bearing surfaces that engage each other and allow for pivotal motion of the link arm about the pivot pin with low frictional losses.

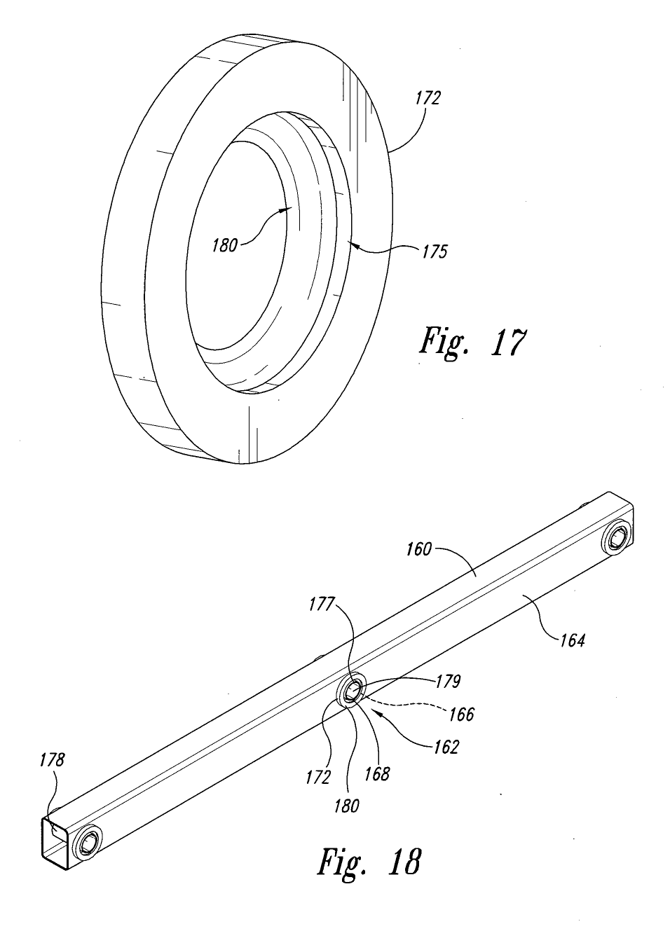

FIG. 17 is an enlarged isometric view of one of the spacers 172 shown removed from the link arm of FIG. 15. FIG. 18 is an isometric view of the link arm 160 and the joint assemblies 162 with the sleeve 168 shown in position relative to the link arm and the spacer 172. The ends 170 of the sleeve 168 are shown in FIG. 18 in a straight configuration before being flared radially outwardly into engagement with the spacer. The spacer 172 in the illustrated embodiment is a ring with an outer diameter greater than the diameter of the apertures 166 in the link arm 160 (FIG. 17). The spacer 172 has a hole 175 therethrough with a diameter slightly larger than the outer diameter of the non-flared portion 179 of the sleeve (FIG. 18). Accordingly, the spacer can be positioned over the sleeve 168 and adjacent to the sidewall 164 of the link arm before the end of the sleeve is flared or otherwise radially expanded.

The spacer 172 in the illustrated embodiment has a contoured recess 180 around the hole 175. The recess is shaped to substantially correspond to the shape of the end 170 of the sleeve 168 when flared. Accordingly, when the ends of the sleeve are flared via cold working the sleeve, the flared ends mate with the contoured recess and rigidly fix the spacer against the sidewall of the link arm without any welding of the components.

The joint assembly 162 of the illustrated embodiment does not include a support sleeve within the link arm's interior area. In other embodiments, the joint assembly 162 can include the support sleeve within the interior area of the link arm and concentrically disposed around the interior sleeve 168. In yet other embodiments, the pivot pin can be retained by other non-welded, mechanical locking means as discussed above. The spacer can include a recess shaped to receive at least a portion of the mechanical locking means (e.g., a snap ring or other locking device).

The link arms 108 and joint assembly 110 as discussed above can be used for the interior or exterior link arms, thereby providing commonality of components for use in an assembly such as a link set for a scissor lift assembly. Accordingly, the numbers of unique parts required to build the assembly is reduced, thereby decreasing the costs of the manufacturing process. In addition, the link arm and the joint assembly are manufactured without welding, so the manufacturing process is less costly and less time consuming. The link arm and joint assemblies also avoid the drawbacks of distortion or warping that can occur with welding of components. The link arm and joint assemblies may also be lighter in weight than conventional welded link arms without a reduction of operational strength. Accordingly, the link sets formed by the link arms with the joint assemblies and used in a scissor lift assembly are more free moving and easier to build than conventional link sets, which translate into an assembly that costs less to manufacture while maintaining the required strength and durability.

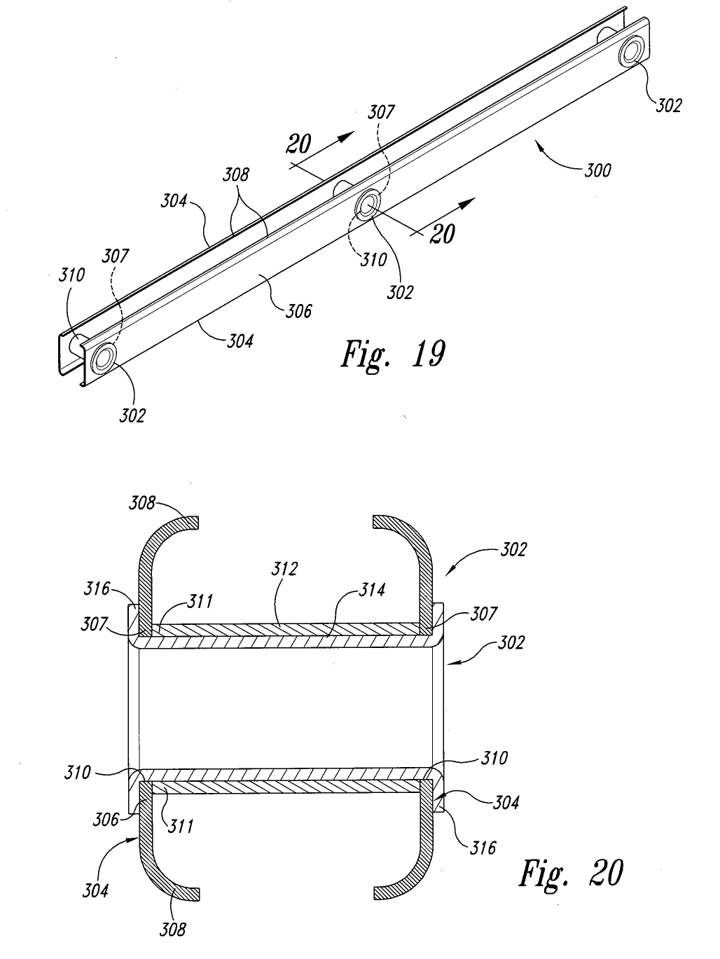

FIG. 19 is an isometric view of a structure, such as a link arm assembly 300 and with three joint assemblies 302 in accordance with another embodiment. FIG. 20 is an enlarged cross-sectional view of the link arm assembly 300 taken substantially along lines 20-20 of FIG. 19. The link arm assembly 300 of the illustrated embodiment includes a pair of spaced apart plates 304 rigidly connected together by the joint assemblies 302. The plates 304 are elongated flanged plates having a web portion 306 extending between a pair of angled flanged portions 308. The flanged portions 308 strengthen and stiffen the plates 304 in bending and in torsion.

Each flanged plate 304 has a plurality of joint apertures 310 therein that receive the joint assemblies 302. In the illustrated embodiment, the flanged plates 304 are configured to be positioned adjacent to each other with the apertures 310 in one plate 304 axially aligned with the apertures in the other plate. Each joint assembly 302 is disposed in the pair of align apertures 310 and securely engaged the portion 307 of the web 306 around the apertures. Accordingly, the joint assemblies 302 rigidly and securely hold the flanged plates together in a fixed spaced apart, substantially parallel arrangement. Accordingly, the flanged plates 308 and the joint assemblies form a rigid assembly that can be used as a link arm, a beam, a boom arm, or other rigid, lightweight, inexpensive structural member.

As best seen in a FIG. 20, the joint assembly 302 of the illustrated embodiment has a similar construction to the joint assembly described above. The joint assembly 302 has a support sleeve 312 extending between the web 306 of the plates 304. The support sleeve 312 has an outer diameter larger than the diameter of the apertures 310 in the web. Accordingly, the support sleeve 312 holds the two flanged plates 304 apart from each other. The inner sleeve 314 is disposed within the support sleeve 312 and extends through the apertures 310 in the plates 304. The ends 316 of the inner sleeve 314 are radially flared, as described in greater detail below, so the portion 307 of the web 306 around the respective aperture 310 is rigidly fixed between the ends 311 of the support sleeve 312 and the flared ends 316 of the inner sleeve 314. This rigid interconnection provides a very strong, non-welded joint that joins the flanged plates together. This joint assembly 302 can be used as part of a pivot joint arrangement, such as between two link arm assemblies, wherein a pivot pin can be positioned through a pair of the aligned joint assemblies, as discussed above. In other embodiments, the joint assembly 302 can be a stand-alone joint that securely joins two or more plates or other structures together in a weld-free arrangement.

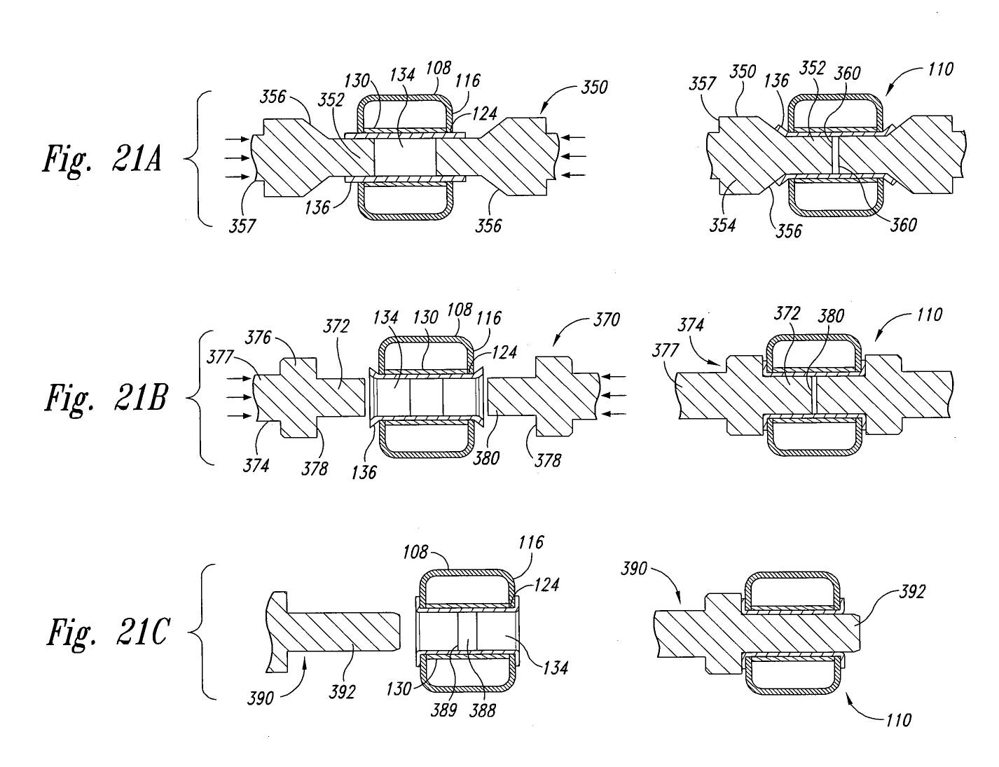

FIGS. 21A-21C are schematic cross-sectional views illustrating the method of forming a joint assembly 110 in accordance with an embodiment of the present invention. The method is discussed in connection with forming a joint assembly 110 in a structural member, such as a link arm 108, although it is to be understood that the method is also applicable to forming a joint assembly in another structure. As an example, the method can be used to form one or more joint assemblies that join two or more independent structures together.

In the illustrated embodiment, the link arm 108 includes a pair of axially aligned apertures 124 in the sidewalls 116. The apertures of the illustrated embodiment are co-axially aligned with a joint axis substantially perpendicular to the longitudinal axis of the link arm In other embodiments, however, the aperatures 124 and the joint assembly can be configured along an axis skewed angle (e.g., non-perpendicular) relative to the longitudinal axis of the link arm.

When the joint assembly 110 is to be installed, the link arm 108 is securely held in a fixed position, such as by a jig, clamp, or other suitable fixture. The joint assembly 110 is formed by positioning the support sleeve 130 between the sidewalls 116 in axial alignment with the apertures 124. As discussed above, the support sleeve 130 is sized so it does not extend through the apertures 124, and it supports the portions of the sidewalls 116 around the apertures 124. Accordingly, the support sleeve blocks the sidewalls from overly deflecting or deforming under compression loads.

While the support sleeve 130 of the illustrated embodiment is a cylindrical sleeve, other embodiments can use non-cylindrical sleeves between the sidewalls 116. In yet other embodiments, other support structures can be positioned between the sidewalls 116 to support the sidewalls under compression loads used to form the joint assembly, discussed in greater detail below. These support structures can remain with the link arm as part of the finished joint assembly. In other embodiments, the support structures can be removable members that are temporarily placed between the sidewalls 116 during formation of the joint assembly, and then removed after the joint assembly is formed.

Referring again to FIG. 21A, after the support sleeve 130 is positioned between the apertures 124, the interior sleeve 134 is inserted through the apertures 124 and into the support sleeve 130 so that the ends 136 of the interior sleeve project outwardly from both sidewalls. In this position, the interior sleeve has an outer diameter that approximates the diameter of the apertures, so the interior sleeve can easily slide through the apertures 120 and the support sleeve, before the ends 136 are flared. In one embodiment, the interior sleeve 134 is positioned so that approximately equally sized end portions project away from the sidewalls 116. In other embodiments, the interior sleeve 134 can be positions so that different lengths of the interior sleeve project from the opposing sidewalls 116.

After the interior sleeve 134 is in position, first flaring dies 350 are inserted from opposite directions into the open ends 136 of the interior sleeve during a plunging stroke. Each first flaring die 350 has a leading portion 352 sized to fit into the interior sleeve. The first flaring die also has a body portion 354 with flaring section 356 and a mounting section 357. In the illustrated embodiment, the flaring section 356 has a partially conical surface configured at approximately 45-degrees relative to the longitudinal axis of the interior sleeve. The mounting section 357 of the body portion 354 is configured to be engaged by a press assembly or other tool that moves the first flaring die into and out of engagement with the interior sleeve. The press assembly or other tool securely retains the first flaring dies 350 in axial alignment with each other and in axial alignment with the interior sleeve 134. The press assembly is configured to simultaneously axially plunge the first flaring dies 350 toward each other at substantially the same rate during the flaring stroke. During the flaring stroke of the illustrated embodiment, the first flaring dies 350 are not rotating relative to the interior sleeve. The press assembly also moves the flaring dies 350 away from each other and out of the interior sleeve 134 during a removal stroke.

In one embodiment, the press assembly begins to move the first flaring dies 350 along the flaring stroke, and the leading portions 352 of each die are simultaneously pressed into the interior sleeve 134. As the flaring stroke continues, the press assembly simultaneously presses the 45-degree flaring sections 356 into the ends 136 of the interior sleeve 136 with sufficient force to plastically deform the ends of the interior sleeve to match the 45-degree angle of the flaring section. As discussed above, the support sleeve 130 surrounding the interior sleeve blocks the sidewalls 116 from substantially deforming under any compression loads exerted on the sidewalls as the flaring dies plunge into and flare the ends of the interior sleeve.

In the illustrated embodiment, the interior sleeve 134 is a steel or other metal tube having a modulus of elasticity such that the ends 136 of the sleeve will undergo the plastic deformation during the flaring stroke without the ends splitting or cracking. Although the first flaring die of the illustrated embodiment has a 45 degree flare, other embodiments can use one or more flaring dies configured to provide a different degree of flare.

At the end of the flaring stroke, the leading portions 352 of the first flaring dies 350 are adjacent to each other within the interior sleeve 134. The press assembly then reverses and the first flaring dies 350 are moved through the removal stroke, wherein the first flaring dies are axially removed from the interior sleeve. Because both ends 136 of the interior sleeve 134 are simultaneously flared during the flaring stroke of the illustrated embodiment, the interior sleeve can not be pulled out of the apertures 124 during the removal stroke.

In one embodiment, the leading portion 352 of the first flaring die 350 has an outer diameter slightly greater than the inner diameter of the interior sleeve 134. The leading portion 352 also has a tapered free end 360 that tapers radially inwardly to an outer diameter less than the inner diameter of the interior sleeve 134. As the flaring dies 350 begin their flaring strokes, the tapered free ends 360 are first pressed into the open ends 136 of the interior sleeve 134 without deforming the interior sleeve.

As the first flaring dies 350 continue along the flaring stroke, the rest of the leading portions 352 are pressed into the interior sleeve, and the larger outer diameter of the leading portion causes portions of the interior sleeve between the apertures to radially expand. The leading portion 352 of each flaring die 350 can be sized to cause plastic deformation of the interior sleeve 134 as the flaring die moves along its flaring stroke, thereby quickly and accurately sizing the inner diameter of the interior sleeve during the flaring stroke.

As best seen in FIG. 21B, the flaring method of the illustrated embodiment includes flaring the ends of the interior sleeve to an approximately 90-degree angle relative to the longitudinal axis of the interior sleeve. In the illustrated embodiment, the ends 136 of the interior sleeve 134 are flared to the 90-degree orientation after the ends have been flared to the 45-degree angle by the first flaring dyes 350, as discussed above. This second flaring step includes simultaneously pressing a pair of second flaring dies 370 into the interior sleeve 134 in a manner similar to pressing the first flaring dies 350 into the interior sleeve discussed above.

Each second flaring die 370 has a leading portion 372 that fits into the interior sleeve, and a body portion 374 with flaring section 376 and a mounting section 377. In the illustrated embodiment, the flaring section 376 of second flaring die 370 has a substantially flat annular shoulder 378 oriented at approximately 90-degrees relative to the longitudinal axis of the inner sleeve 134. The mounting section 377 of the body portion 374 is coupled to the press assembly or other tool as discussed above. The press assembly or other tool securely holds the second flaring dies 370 in axial alignment with each other and in axial alignment with the interior sleeve 134. The press assembly simultaneously moves the second flaring dies 370 toward each other at substantially the same rate during the flaring stroke and away from each other during the removal stroke.

In one embodiment, the press assembly begins to move the second flaring dies 370 along the flaring stroke, and the leading portions 372 of each die are simultaneously pressed into the interior sleeve 134. As the flaring stroke continues, the press assembly simultaneously presses the flat annular shoulder 378 against the 45-degree flared ends 136 of the interior sleeve 136, thereby further flaring the ends 136 radially outwardly.

At the end of the flaring stroke, the leading portions 372 of the second flaring dies 370 are adjacent to each other within the interior sleeve 134. The flat annular shoulder 378 of the flaring sections 376 is immediately adjacent to the sidewalls 116, whereby the flared ends 136 of the interior sleeve 136 is oriented at a 90-degree angle and positioned immediately adjacent to the sidewalls 116. Although the second flaring die 370 of the illustrated embodiment has a 90 degree flare, other embodiments can use one or more flaring dies configured to provide a different degree of flare.

Upon completion of the flaring stroke, the press assembly reverses and the second flaring dies 370 are moved through the removal stroke, wherein the second flaring dies are removed from the interior sleeve 134. Accordingly, the interior sleeve 134 and the support sleeve 130 are securely fixed in place in the apertures 124 in the link arms without requiring any welding.

In one embodiment, the leading portion 372 of the second flaring die 370 can also have a tapered free end 380 that tapers from an outer diameter slightly greater than the inner diameter of the interior sleeve 134, similar to the first flaring die 350 discussed above. Accordingly, as the second flaring dies 370 move through the flaring stroke, the leading portion 372 causes the interior sleeve to slightly radially expand, thereby simultaneously sizing and conditioning the inner surface of the interior sleeve. While the above embodiment is described with the leading portions 352 and 372 of the first and second flaring dies configured to radially expand the inner surface of the interior sleeve between the apertures, other embodiments can be configured so that the leading portions 352 and 372 of only the first or second flaring dies 350 or 370 will radially expand the portion of the interior sleeve between the apertures. In other embodiments, the leading portions 352 and 372 of the first and second flaring dies 350 and 370 can be configured so the leading portions do not plastically deform the portion of the interior sleeve between the apertures.

When the pair of first and/or second flaring dies 350/370 radially expands the interior sleeve 134 between the apertures, a middle portion 388 of the interior sleeve that is adjacent to the tapered free ends of the flaring dies 350/370 will not be radially flared. Accordingly, the interior of the sleeve may have an annular bump 389 therein. In one embodiment illustrated in FIG. 21C, a plunging die 390 can be pressed through the interior sleeve 134 from either end to smooth out the annular bump 389.

In the illustrated embodiment, the 390 plunging die has an elongate plunging portion 392 with an outer diameter substantially identical to or slightly larger than the outer diameter of the leading portions 352/372 of the first and/or second flaring dyes 350/370. The plunging portion 392 is moved through a plunging stroke so as to radially expand at least the middle portion of the interior sleeve's inner surface. The plunging portion is then removed from the interior sleeve during a removal stroke. As a result, the inner surface of the interior sleeve is cold worked to provide the desired inner diameter and surface condition without having to ream, drill or otherwise remove material from the inner sleeve.

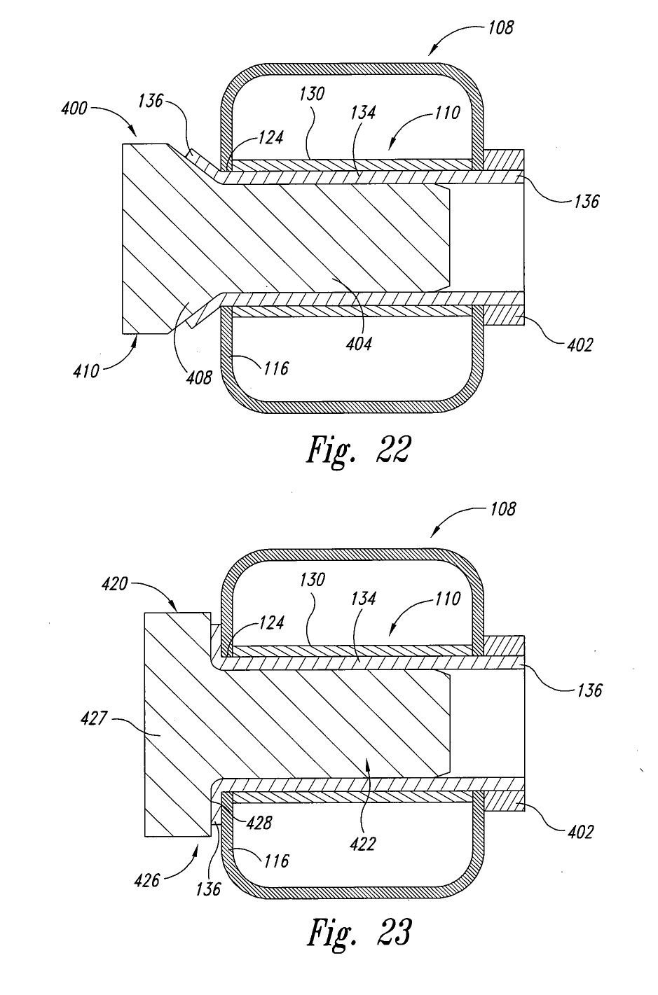

While the above embodiments flare both ends 136 of the interior sleeve 134 simultaneously, other embodiments can flare one end of the interior sleeve at a time. FIG. 22 is a schematic cross-sectional view of a first flaring die 400 positioned in a joint assembly 110 during an intermediate step of flaring one end 136 of the interior sleeve 134. In this embodiment, after the support sleeve 130 is positioned between the sidewalls 116 and the apertures 124 as discussed above, the interior sleeve 134 is inserted through the apertures 124 and the support sleeve 130, so the ends 136 of the interior sleeve project outwardly from the sidewalls. One end of the interior sleeve 134 is temporarily positioned in or adjacent to a spacer 402 that engages the sidewall 116. In the illustrated embodiment, the spacer 402 is an annular ring that temporarily receives a free end of the interior sleeve 134 during the flaring process. The spacer 402 helps maintain the axial position of the interior sleeve 134 relative to the link arm 108 or other structure while the other end 136 of the interior sleeve 134 opposite the spacer is flared.

After the interior sleeve 134 is in position, the first flaring die 400 is plunged into the open end 136 of the interior sleeve opposite the spacer 402. The flaring die 400 has a leading portion 404 that fits into the interior sleeve. The flaring die 400 also has a flaring section 408 and a mounting section 410, similar to the first flaring die 350 discussed above. In the illustrated embodiment, the flaring section 408 provides a 45-degree flare, although the flaring section can be configured to provide a different flare angle. The mounting section 410 is also configured to be coupled to a press assembly or other tool that moves to flaring die into and out of engagement with the interior sleeve, as discussed above.

The press assembly securely retains the first flaring die 400 in axial alignment with the interior sleeve 134 and presses the flaring section 408 along a flaring stroke into the end of the interior sleeve, thereby plastically deforming and radially expanding the end of the interior sleeve to approximately a 45-degree angle. The first flaring die 400 also can be configured to radially expand the inner surface of the interior sleeve, as discussed above. The first flaring die is then moved along a removal stroke and removed from the interior sleeve as discussed above.

As best seen in FIG. 23, a second flaring die 420 can then be used to flare the end 136 of the interior sleeve 134 to the approximately 90-degree angle while the opposite end of the interior sleeve remains unflared and adjacent to the spacer 402. The second flaring die 420 also has a leading portion 422 that fits into the interior sleeve, a flaring section 426 that flares end of the interior sleeve, and an mounting section 427 couplable to the press assembly. In the illustrated embodiment, the flaring section 426 of second flaring die 420 has a substantially flat annular shoulder 428 configured at approximately 90-degrees relative to the longitudinal axis of the inner sleeve 134, substantially similar to the second flaring die 370 discussed above. In one embodiment, the press assembly presses the flat annular shoulder 428 against the 45-degree flared end 136 of the interior sleeve 136, thereby flaring the end radially outwardly to a 90-degree angle. Although the second flaring die 420 of the illustrated embodiment provides has a 90 degree flare, other embodiments can use one or more flaring dies configured to provide a different degree of flare. In addition, the second flaring die 420 can be configured in at least one embodiment to radially expand the inner surface of the interior sleeve, as discussed above. In another embodiment, the second flaring die 420 is configured to extend into the interior sleeve without radially expanding the inner surface as discussed above.

Upon completion of the flaring stroke, the second flaring die 420 is reversed and moved through the removal stroke, wherein the second flaring die is removed from the interior sleeve 134. After the first end 136 of the interior sleeve 134 has been flared, the first and second flaring dies can be used to flare the other end of the interior sleeve, in substantially the same manner as discussed above. When flaring this second end of the interior sleeve, however, the spacer ring is not needed. A plunger die can then be passed through the interior sleeve as discussed above, as needed to cold work and condition the inner surface of the interior sleeve between the apertures 124.

The resulting joint assembly in a link arm, structural member, or other members provides a very strong, rigid joint to support a pivot arrangement or to fix two components together. The joint is weldless and it is substantially less labor intensive and less expensive than conventional welded joints. The joint assembly works with the structural member(s), so that fewer parts are needed, resulting in a lighter weight assembly without sacrificing strength or performance. In addition, the amount of time and man-power needed for manufacturing is substantially reduced, at least in part because the assembly is not welded.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A link arm assembly for use in a link set of a scissor lift assembly, comprising:
A link arm having a pair of sidewalls spaced apart from each other, each of the sidewalls having a plurality of apertures having a first diameter, each of the plurality of apertures in one sidewall being axially aligned with another one of the apertures in the other sidewall; and
A joint assembly comprising:
A support sleeve positioned between the sidewalls and aligned with a pair of the apertures in the sidewalls, the support sleeve having an outer diameter greater than the first diameter of the apertures; and
An interior sleeve concentrically disposed within the support sleeve, the interior sleeve having end portions extending through the pair of apertures and projecting beyond the sidewalls, the end portions having cold worked radially flared portions adjacent to the sidewalls, the radially flared portions having a diameter greater than the first diameter of the apertures, and wherein a portion of the sidewalls around the aperture is fixedly captured between the radially flared portion of the interior sleeve and the support sleeve.

2. The link arm assembly of claim 1 wherein the link arm is a open channel member with opposing sidewalls integrally connected to an endwall.

3. The link arm assembly of claim 1 wherein the link arm is at least one of a U-channel and a C-channel.

4. The link arm assembly of claim 1 wherein the link arm has at least first and second pairs of axially aligned apertures, and wherein the joint assembly is a first joint assembly disposed in a first pair of the apertures, and further comprising a second joint assembly disposed in the second pair of axially aligned apertures.

5. The link arm assembly of claim 1 wherein the link arm is a pair of flanged plates spaced apart from each other and with web portions of the flanged plates defining the sidewalls and being interconnect by the joint assemblies.

6. The link arm assembly of claim 1 wherein the link arm has a boxed-beam cross section, and further comprising at least one access aperture adjacent to at least one of the apertures.

7. The link arm assembly of claim 1 wherein the radially flared portions of the interior sleeve are flared at approximately a 90-degree angle relative to a longitudinal axis of the interior sleeve.

8. The link arm assembly of claim 1 wherein the radially flared portions of the interior sleeve are flared at less than a 90-degree angle relative to a longitudinal axis of the interior sleeve.

9. The link arm assembly of claim 1 wherein the radially flared portions of the interior sleeve are flared at approximately a 45-degree angle relative to a longitudinal axis of the interior sleeve.

10. The link arm assembly of claim 1 wherein the interior sleeve has an inner surface that has been cold worked to a selected surface condition during installation of the joint assembly.

11. The link arm assembly of claim 1 wherein interior sleeve has an inner surface coated with a lubricious material that forms a bearing surface.

12. The link arm assembly of claim 1, further comprising a pivot pin disposed in the joint assembly and configured to pivotally couple the link arm a second link arm.

13. The link arm assembly of claim 1 wherein the joint assembly further comprising a spacer captured between the sidewall and the radially flared portion.

14. The link arm assembly of claim 1 wherein the link arm is a first link arm, and the joint assembly is a first joint assembly, further comprising a second link arm configured substantially identical to the first link arm and a second joint assembly configured substantially identical to the first joint assembly, wherein the first and second link arms are pivotally coupled together by pivot member connected to the first and second joint assemblies.

15. A scissor lift assembly, comprising:
A plurality of link arms pivotally coupled together to form an scissoring link set, each of the link arm having a pair of sidewalls spaced apart from each other, each of the sidewalls having a plurality of apertures having a diameter, each of the plurality of apertures in one sidewall of a link arm being axially aligned with another one of the apertures in the other sidewall; and
A plurality of joint assemblies attached to the link arms, each joint assembly having an interior sleeve extending through the pair of apertures and having end portions projecting beyond the sidewalls, the end portions having cold worked, radially flared portions adjacent to the sidewalls, the end portions being in fixed engagement with portions of the sidewalls around the apertures, the radially flared portions having a diameter greater than the diameter of the apertures; and
A pivot member connected to adjacent joint assemblies of two adjacent link arm and configured allow the two adjacent link arms to pivot relative to each other at the joint assemblies and about the pivot member.

16. A scissor lift assembly of claim 15, wherein each joint assembly includes a support sleeve positioned between an aligned pair of the apertures in the sidewalls of the link arm, the support sleeve having an outer diameter greater than the diameter of the apertures, and wherein a portion of the sidewalls around the aperture is fixedly captured between the radially flared portion of the interior sleeve and the support sleeve.

17. A scissor lift assembly of claim 15 wherein the link arms are open channel members with opposing sidewalls integrally connected to an endwall.

18. A scissor lift assembly of claim 15 wherein the link arms are U-channels.

19. A scissor lift assembly of claim 15 wherein at least one of the link arms includes a pair of flanged plates spaced apart from each other and with web portions of the flanged plates defining the sidewalls and being interconnect by the joint assemblies.

20. A scissor lift assembly of claim 15 wherein the radially flared portions of the interior sleeve are flared at approximately a 90-degree angle relative to a longitudinal axis of the interior sleeve.

21. A scissor lift assembly of claim 15 wherein the radially flared portions of the interior sleeve are flared at approximately a 45-degree angle relative to a longitudinal axis of the interior sleeve.

22. A scissor lift assembly of claim 15 wherein the interior sleeve has an inner surface that has been cold worked to a selected surface condition during installation of the joint assembly.

23. A scissor lift assembly of claim 15 wherein interior sleeve has an inner surface coated with a lubricious material that forms a bearing surface.

24. A structural member, comprising:
An elongated member having a pair of spaced apart sidewalls with a pair of aligned apertures therein, the apertures having a diameter; and
A joint assembly comprising:
A support member positioned between the sidewalls and aligned with the apertures, the support member having an outer dimension greater than the diameter of the apertures so the support member will not pass through the apertures; and
An interior sleeve disposed adjacent to the support member and extending through the apertures, the interior sleeve having end portions projecting beyond the sidewalls, the end portions being cold worked, radially flared portions adjacent to the sidewalls, the radially flared portions having an outer diameter greater than the diameter of the apertures, and wherein a portion of the sidewalls around the apertures are fixedly captured between the radially flared portion of the interior sleeve and the support member.

25. The structural member of claim 24 wherein the elongated member is a open channel member.

26. The structural member of claim 24 wherein the elongated member is a link arm of a link set for a scissor lift.

27. The structural member of claim 24 wherein the elongated member comprises a pair of flanged plates spaced apart from each other and with web portions of the flanged plates defining the sidewalls and being interconnect by the joint assembly.

28. The structural member of claim 24 wherein the radially flared portions of the interior sleeve are flared at approximately a 90-degree angle relative to a longitudinal axis of the interior sleeve.

29. The structural member of claim 24 wherein the radially flared portions of the interior sleeve are flared at less than a 90-degree angle relative to a longitudinal axis of the interior sleeve.

30. The structural member of claim 24 wherein the structural member is a sleeve concentrically disposed around the interior sleeve.

31. The structural member of claim 24 wherein the interior sleeve has an inner surface that has been cold worked to a selected surface condition during installation of the joint assembly.

32. A joint assembly, comprising:
A first member having a first aperture;
A second member spaced apart from the first member and having a second aperture axially aligned with the first aperture,
A support member positionable between the first and second members to support at least a portion of the first and second members, the support member being in alignment with the apertures, the support member being sized so the support member will not pass through the apertures; and
An interior sleeve disposed adjacent to the support member and extending between the first and second members and through the first and second apertures, the interior sleeve having end portions projecting beyond the first and second members, the end portions being cold worked, radially flared portions adjacent to the first and second members about the first and second apertures, the radially flared portions having an outer diameter greater than the diameter of the first and second apertures, and wherein portions of the first and second member around the first and second apertures are fixedly captured between the radially flared portions of the interior sleeve and the support member.

33. The joint assembly of claim 32 wherein the first and second members are sidewalls of a link arm.

34. The joint assembly of claim 32 wherein the first and second members are flanged plates spaced apart from each other and with web portions of the flanged plates defining the sidewalls and being interconnect by the joint assembly.

35. A method of joining first and second member having apertures therein, comprising:
Securing the first and second members in a spaced apart relationship with the apertures axially aligned with each other;
Placing a support member adjacent to the apertures and between the first and second members and to block the first and second members from moving toward each other past a selected distance;
Inserting an interior sleeve through the aligned apertures in the first and second members, wherein unflared end portions project away from the first and second members in opposite directions;
Radially flaring the end portions of the interior sleeve by cold working the end portions; and
Fixedly capturing portions of the first and second members around the apertures between the radially flared portions of the interior sleeve and the support member to lock the joint assembly in place.

36. The method of claim 35 wherein the step of radially flaring the end portions of the interior sleeve include plunging a flaring die into the interior sleeve and causing the end portions to plastically deform to the radially flared position.
